(19) United States
(12) Patent Application Publication
(10) Pub. No.: US 2016/0300255 A1
(43) Pub. Date: Oct. 13, 2016

(54) METHOD AND SYSTEM FOR MONETIZING PRODUCTS AND SERVICES USAGE

(71) Applicants: Shamir Shmuel SNIR, Kadima (IL); Shimshon NAGAR, Netanya (IL)

(72) Inventors: Shamir Shmuel SNIR, Kadima (IL); Shimshon NAGAR, Netanya (IL)

(21) Appl. No.: 15/037,429

(22) PCT Filed: Dec. 30, 2014
(86) PCT No.: PCT/IL14/51135

§ 371 Date: May 18, 2016

Related U.S. Application Data
(60) Provisional application No. 61/921,643, filed on Dec. 30, 2013.

(51) Int. Cl. G06Q 30/02; G06F 17/30

(52) U.S. Cl. CPC G06Q 30/0215; G06F 17/3053

(57) ABSTRACT

The present invention provides a platform for allocation assets in relation to consumer usage of multiple application, products or services. The platform is comprised of: policy wizard module enabling an application owner to determine a business model by defining application usage parameters, rewarding conversion rules and assets allocation conversion rules, data usage collection module for aggregating usage parameters data from each, application, product or service API according to defined usage parameters, reward evaluation module for determining and updating user rewards scoring based on aggregated usage data by applying determined rewarding conversion rules and fmancial tool for applying business model conversion rules for allocating assets to the consumer based on their rewards.

### BACKGROUND

### Technical Field

The present invention relates generally to system for monetizing products or services, more particularly, the present invention integration of monetizing consumer usage of products and services with business model of the company.

### DISCUSSION OF RELATED ART

### Brief Summary

The present invention provide a computerized platform implemented on at least one server for allocation of assets in relation to consumer usage or rating of at least one application running on computer device, or services. The platform is comprised of: policy wizard module enabling an application owner to determine a business model by defining application usage parameters or user rating data, rewarding conversion rules and assets allocation conversion rules, reward evaluation module for determining and updating user rewards scoring based on aggregated usage data or user rating data by applying determined rewarding conversion rules and financial tool for applying business model conversion rules for supporting the allocation of assets to the consumer based on their rewards.

According to some embodiments of the present invention the computerized platform comprising data usage collection module for aggregating usage parameters data from each application, product or service API according to defined usage parameters. According to some embodiments of the present invention the policy wizard determine or update the business module by applying a designated GUI process including at least one of the fowling steps: defining the business module parameters including at least one of: type of financial assets or profit formula rules, defining usages parameters of the application or ranking rating of user, product or service relevant for the business model including usage parameters, usage statistics, content provide by the user, defining rewards conversion rules for the business model which define the calculation of the rewards form usage parameters and defining the assets allocation rules which determine the financial calculation of the financial assets values from the calculated rewards.

According to some embodiments of the present invention further comprising policy engine module which process the following steps: retrieving the business module parameters for each application products or service as defined by the owner together with the updated financial information of the owner, wherein based on the received information, the module determines or update the contract rules of the consumer based on current business model and generates Owner & End User Agreement.

According to some embodiments of the present invention the policy engine module further converts the updated contract state in to financial assets allocation based on the business model.

According to some embodiments of the present invention the reward evaluation module receives the aggregated usage data of the consumer, analyzes statistics of usages for user or ranking at predefined time periods, wherein based on analyzed usage statistics the business module reward conversion rules are applied to determine accumulated rewards of each user.

According to some embodiments of the present invention the accumulated rewards are recorded in the a client's database, wherein the database may store for each users all accumulated rewards for all type of applications, products and service, and provide each client full report of his rewards in comparison to his usage parameters.

According to some embodiments of the present invention the monetary module receives the accumulated rewards of the clients and applies the allocation conversion rules based on the business model and client personal information for calculating accumulated assets values of each client and store them in the client database.

According to some embodiments of the present invention wherein the monetary module applies predefined countries rules adapted to business model asset allocation rules for calculating accumulated assets values of each client.

According to some embodiments of the present invention the monetary module, further provides connectivity and integration with financial tools for allocating/carrying out the financial outcome of the calculated allocated assets values, wherein the allocated assets values are stored in the financial transaction database.

The present invention provide a method implemented by main processor on at least one server for allocation of assets in relation to consumer usage of multiple application, products or services. The method comprising the steps of: determining a business model using client processing terminal by defining application usage parameters or user rating data, rewarding conversion rules and assets allocation conversion rules, determining and updating by user rewards scoring based on aggregated usage data or user rating data by applying determined rewarding conversion rules; and applying business model conversion rules for supporting the allocation of assets to the consumer based on their rewards.

The present invention provides a platform for allocation assets in relation to consumer usage of multiple application, products or services. The platform is comprised of: policy wizard module enabling an application owner to determine a business model by defining application usage parameters, rewarding conversion rules and assets allocation conversion rules, data usage collection module for aggregating usage parameters data from each, application, product or service API according to defined usage parameters, reward evaluation module for determining and updating user rewards scoring based on aggregated usage data by applying determined rewarding conversion rules and financial tool for applying business model conversion rules for allocating assets to the consumer based on their rewards;

### BRIEF DESCRIPTION OF THE DRAWINGS

The present invention will be more readily understood from the detailed description of embodiments thereof made in conjunction with the accompanying drawings of which:

FIG. 1 shows a high level block diagram of modules that are arranged to provide monetize usage of products or services, according to some embodiments of the invention;

FIG. 2 shows a flowchart diagram illustrating activity “Policy wizard module” Module, according to some embodiments of the invention;

FIG. 3 shows a flowchart diagram illustrating activity of a “Policy engine” Module, according to some embodiments of the invention;

FIG. 4 shows a flowchart diagram illustrating “Usage collection module”, according to some embodiments of the invention;

FIG. 5 shows a flowchart diagram illustrating an activity of “Reward Evaluation module”, according to some embodiments of the invention;

FIG. 6 shows a flowchart diagram illustrating “Monetary/financial module”, according to some embodiments of the invention;

FIG. 7 shows a flowchart diagram illustrating “Financial allocation module for applications”, according to some embodiments of the invention; and FIG. 8 shows a flowchart diagram illustrating “Financial allocation module for services”, according to some embodiments of the invention;

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

### Definitions

The term “ financial assets” as used herein thorough the application, relates to any valuable benefit such as money, option, stock, products, services, discounts, coupons.

The term “ usage parameters” as used herein thorough the application, relates to any action or function provide by the application which is applied by the user when using an application program or using a service, such as opening the application, sharing the application, entering data to the application.

The term “computerized device” as used herein thorough the application, relates any computer enabled device, such as PC, smart phone device, wearable electronic device, etc.

The present invention provides, computerized platform, implemented in computerized processing unit using a central server, for providing one stop solution for allocating financial assets to customers of companies based on user or customers behavior. The customer behavior data can be aggregated by the company itself based on it's customer loyalty clubs or other rating data tools, or in association with the computerized platform, by defining usage parameters to be tracked. The allocation of the financial assets, is based on company business model which define the rules for compensating the client on the basis of their contribution to the company.

The platform integrates data of usage, rating or sharing operation through API module in designated application or service module of the owner.

The same platform can be implemented by cooperatives organization, in the business module define customers share in the companies assets or profits.

According to some embodiments, the platform can be used in association with crowd funding organizations, in which the customers are receive rewards of products in return for funding the product development. The platform may enhance the customer relationship after the products have provided to customer, enabling to further allocate financial assets based on product usage.

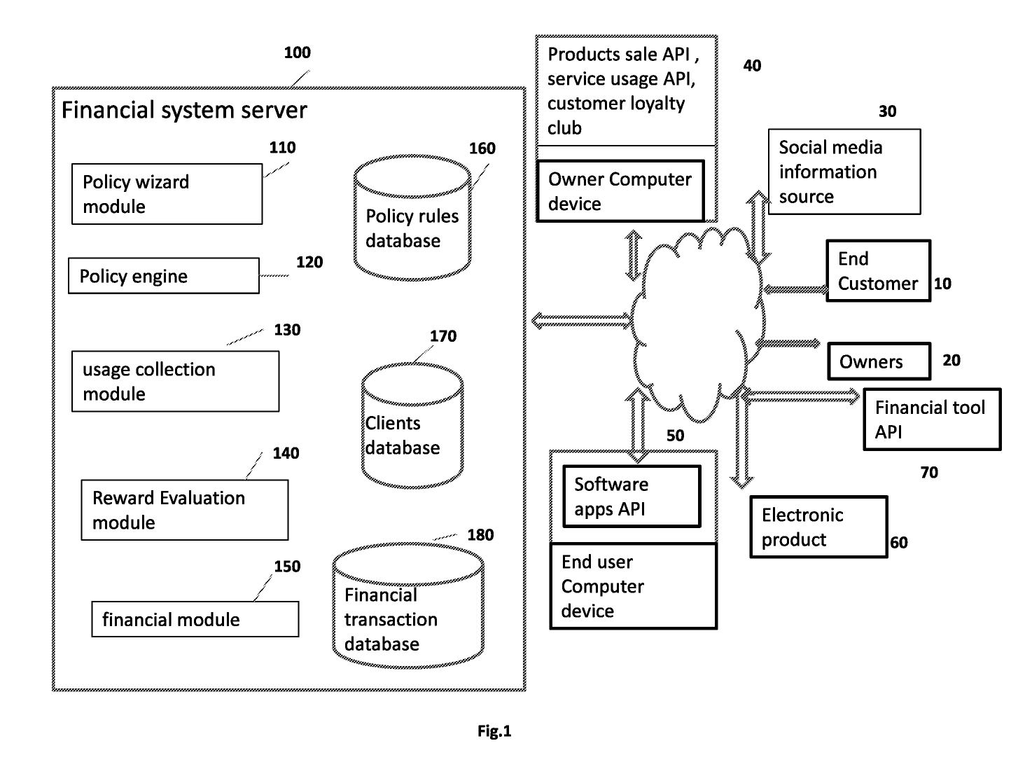

FIG. 1 shows a high level block diagram of modules that are arranged to provide the ability to determine financial assets allocation to customers based on the usage of products or services by the consumer and their contribution to the owner 20, according to some embodiments of the invention. The financial system 100 enables a products or service owner 20 to integrate the financial assets allocation method with their business model. The owner 20 can use the Policy wizard module 110 to define and or update the financial assets allocation method according to his business module and define conversion rules in association to the user/consumer usage parameters. The policy engine 120 receives the company updated financial information and generates or updates client agreements. The “usage collection module” 130 pols and gathers, usage information or user rating/scoring, which can be originated by Products sale API 40, software app API 50, electronic product API 60 or optionally receiving data from social network sources indicating of sharing actions of the user related to the application, service or product. The gathered information is analyzed by the “reward Evaluation module” 140, for calculating the accumulated rewards of each client. The “Monetary/financial module” calculates the financial assets allocation or monetized assets allocated for each user, and provides an integrated action with a financial tool API 70 to carry out the required financial transaction. The user rating or score may information gathered by the owner.

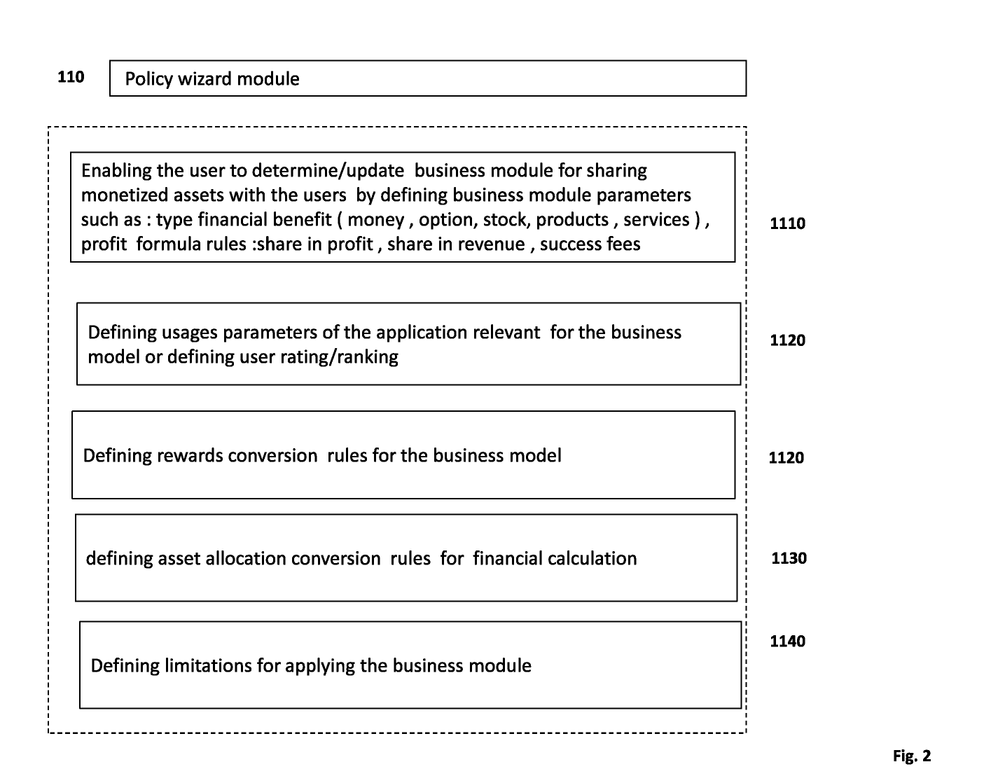

FIG. 2 shows a flowchart diagram illustrating activity “Policy wizard module”, according to some embodiments of the invention. The “policy wizard module” 110, enables the owner 20 to determine or update the business module by using a designated GUI which guides the owner through the process: at the first stage (step 1110) the owner can define the business module parameters such as: type of financial assets (money, option, stock, products, services), profit formula rules such as share in profit, share in revenue, success fees etc., at the second stage (step 1120), defining usages parameters of the application, ranking or rating of the user parameters, the application or service relevant for the business model such type of usage parameters, such as usage statistics, content generation, sharing or any social activities(e.g. sharing) applied by the user, at the third stage (step 1130) the owner may define rewards conversion rules for the business model which define the calculation of the rewards form usage parameters or user ranking parameters, at the fourth stage the owner may define (step 1140) the assets allocation rules which determine the financial calculation of the financial assets values from the calculated rewards.

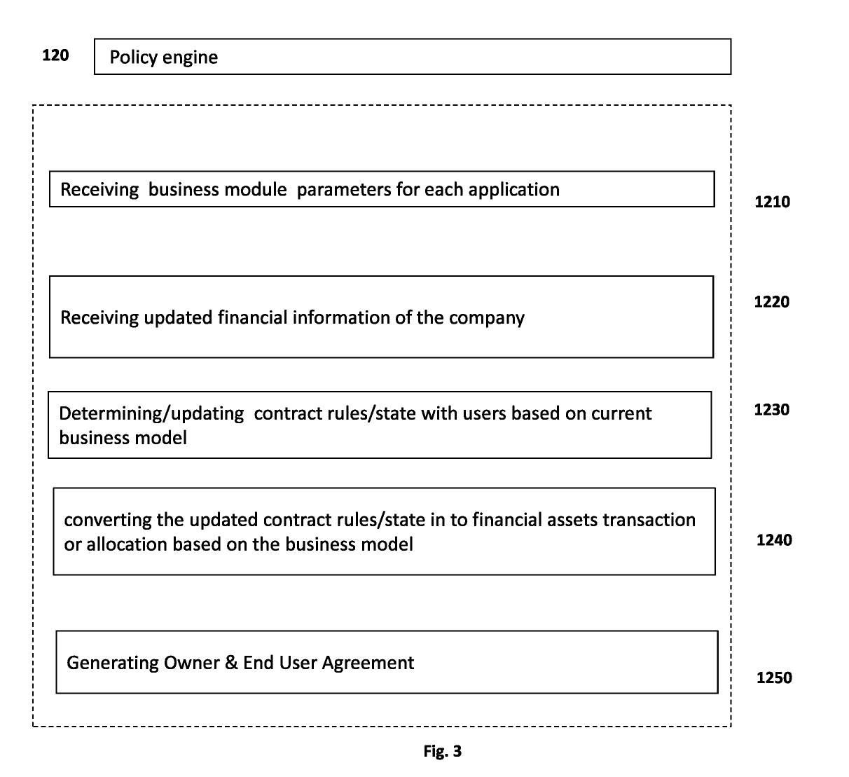

FIG. 3 shows a flowchart diagram illustrating activity of a “Policy engine”, according to some embodiments of the invention. The “policy engine” retrieves the business module parameters for each application products or service as defined by the owner (step 1210) together with the updated financial information of the owner (step 1220). Based on the received information, the module can determine or update the contract rules/state of the user/consumer based on current business model (step 1230) and Generating Owner & End User Agreement (step 1250). The module may further convert the updated contract rules/state into financial assets allocation or transaction based on the business model (step 1240).

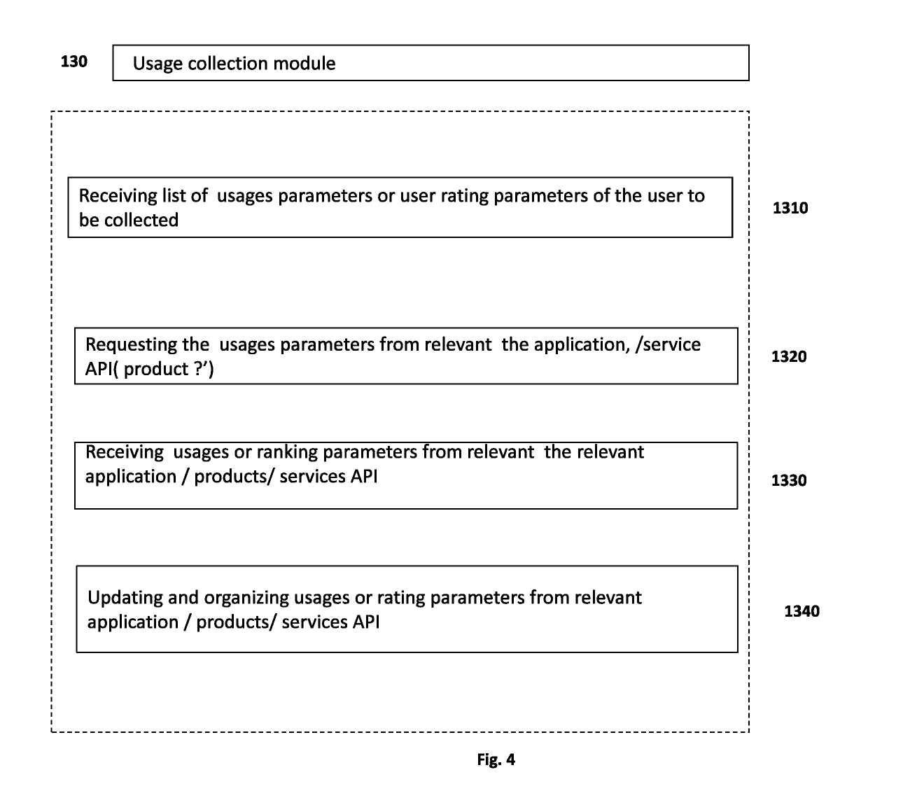

FIG. 4 shows a flowchart diagram illustrating “Usage collection module”, according to some embodiments of the invention. The “Usage collection module” receives the list of usages parameters to be collected for each application or product or services (step 1310) and requests the required usages parameters from relevant the application, product/service API (step 1320). The usages parameters are received (step 1330) from the relevant application/product/services API and are updated and organized (step 1330) in “clients database” 170.

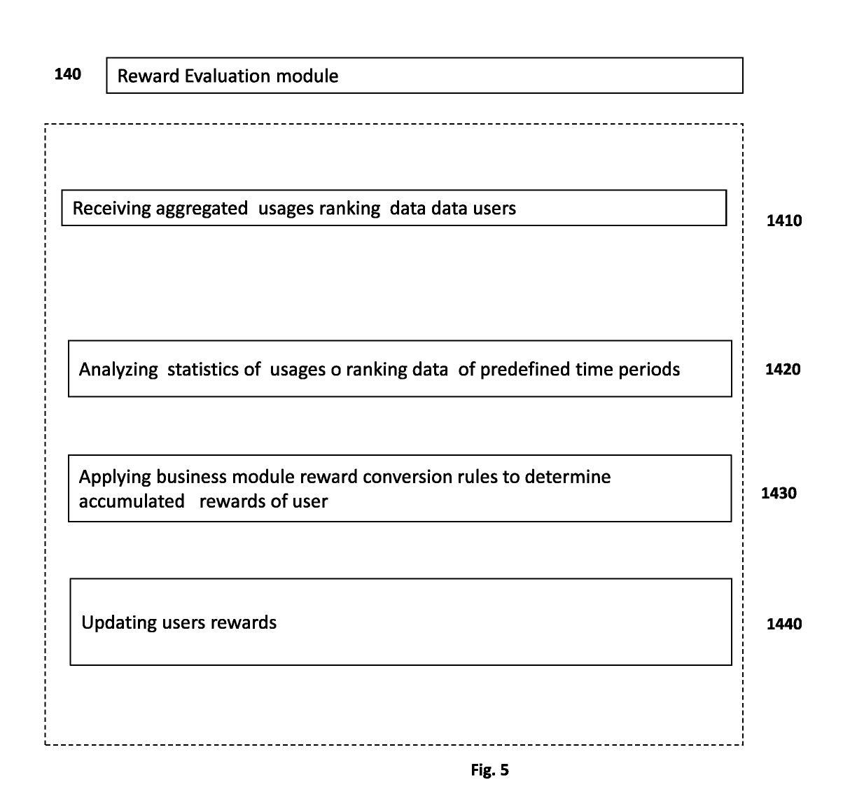

FIG. 5 shows a flowchart diagram illustrating an activity of “Reward Evaluation module”, according to some embodiments of the invention. The “Reward Evaluation module” receives the aggregated usage data of the consumer (step 1410), and analyzes statistics of usages for predefined time periods (step 1420). Based on analyzed usage statistics business module reward conversion rules are applied to determine accumulated rewards of user (step 1430). The accumulated rewards are recorded in the “clients database” 170. This database may store for each user all accumulated rewards for all type of application, products and service, and provide each client full report of his rewards in comparison to his usage parameters.

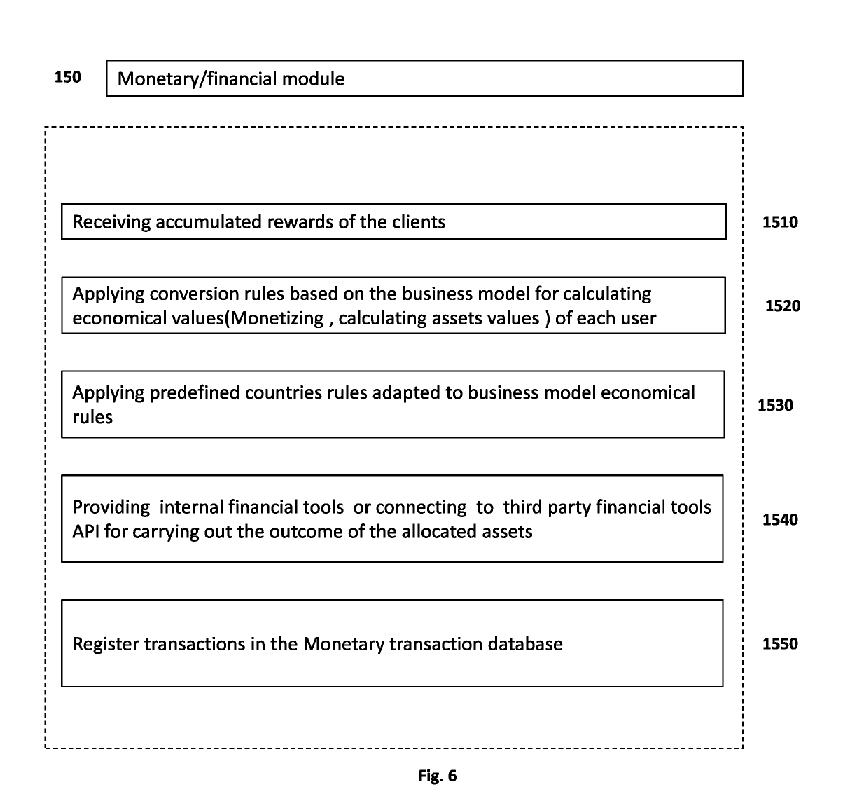

FIG. 6 shows a flowchart diagram illustrating “Monetary/financial module”, according to some embodiments of the invention. The “monetary/financial module”, receives the accumulated rewards of the clients(step 1510) and applies the allocation conversion rules based on the business model and client personal information for calculating accumulated assets values of each client and store them in the client database 180 (1520). Optionally, are applied predefined countries rules adapted to business model asset allocation rules for calculating accumulated assets values of each client (step 1530). The module further provides connectivity and integration with financial tools (e.g. payment platforms such as PayPal, or brokering services for allocating/carrying out the financial outcome of the calculated allocated assets values (step 1540). registered The allocated assets values are stored in the “financial transaction database” (step 1550).

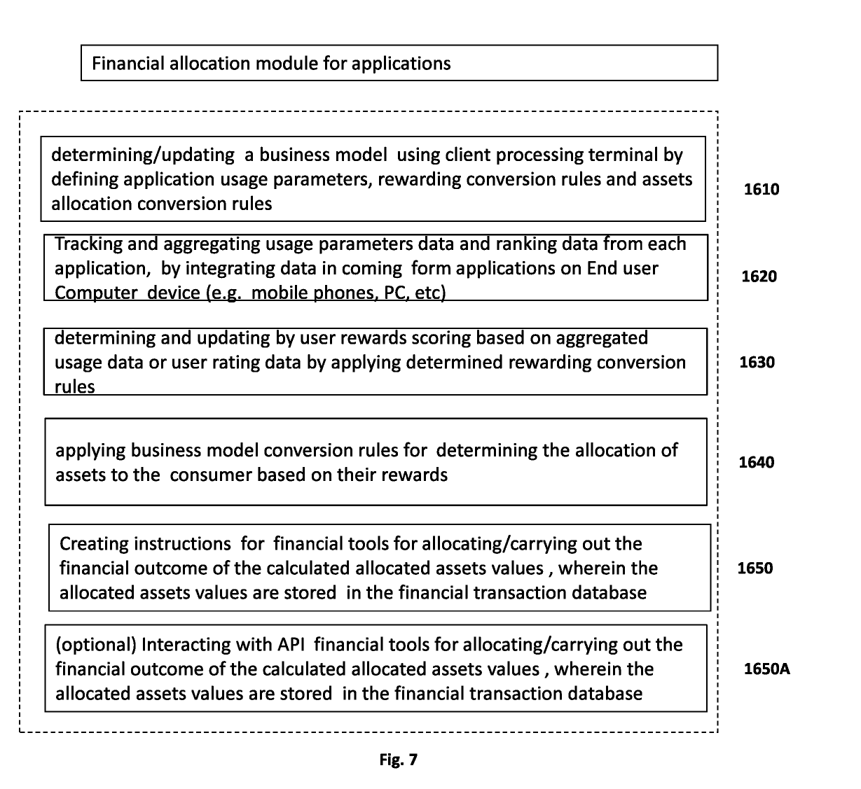

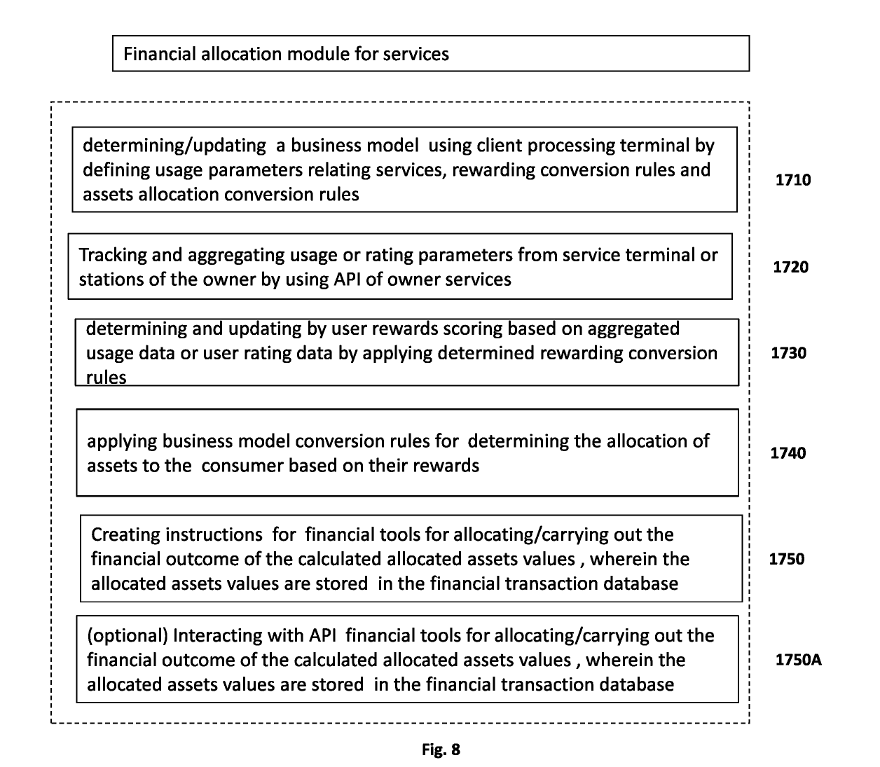

FIG. 7 shows a flowchart diagram illustrating “Financial allocation module for applications”, according to some embodiments of the invention. This module describes the main steps for allocating financial assets, based on user behavior when using application installed on smartphone or computers devices: determining or updating a business model using client processing terminal by defining application usage parameters relating services, rewarding conversion rules and assets allocation conversion rules(step 1610), tracking and aggregating usage parameters data and ranking data from each application, by integrating data identified by applications on mobile phones using designated API (step 1620), determining and updating by user rewards scoring based on aggregated usage data or user rating data by applying determined rewarding conversion rules (step 1630), applying business model conversion rules for determining the allocation of assets to the consumer based on their rewards (step 1640), Creating instructions for financial tools for allocating/carrying out the financial outcome of the calculated allocated assets values, wherein the allocated assets values are stored in the financial transaction database or optionally Interacting with API financial tools for allocating/carrying out the financial outcome of the calculated allocated assets values, wherein the allocated assets values are stored in the financial transaction database(step 1650 or 1650A).

FIG. 8 shows a flowchart diagram illustrating “Financial allocation module for services”, according to some embodiments of the invention. This module describes the main steps for allocating financial assets, based on user behavior when using services provided by the owner though computer devices or service stations such as stores or: determining or updating a business model using client processing terminal by defining usage parameters relating services, rewarding conversion rules and assets allocation conversion rules(step 1710), Tracking and aggregating usage parameters from service terminal or stations of the owner by using API of owner services (step 1720), determining and updating by user rewards scoring based on aggregated usage data or user rating data by applying determined rewarding conversion rules (step 1730), applying business model conversion rules for determining the allocation of assets to the consumer based on their rewards (step 1740), creating instructions for financial tools for allocating/carrying out the financial outcome of the calculated allocated assets values, wherein the allocated assets values are stored in the financial transaction database or optionally Interacting with API financial tools for allocating/carrying out the financial outcome of the calculated allocated assets values, wherein the allocated assets values are stored in the financial transaction database(step 1750 or 1750A).

According to some embodiments of the present invention it, is suggested to provide the uses with periodical statistical reports of their data usage, rating data, calculated rewards an or allocated financial assets for each application or service they are using. The user may be updated each time the user agreement has changed due changes in the business module of the owner.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus/computer device or server of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “allocating”, “applying” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

What is claimed is:

1. A computerized platform implemented on at least one server for allocation of assets in relation to consumer usage or rating of at least one application running on computer device, or services, said platform comprised of:
policy wizard module implemented on processing unit enabling an application owner to determine a business model by defining application usage parameters or user rating data, rewarding conversion rules and assets allocation conversion rules;
reward evaluation module implemented on processing unit for determining and updating user rewards scoring based on aggregated usage data or user rating data by applying determined rewarding conversion rules; and
financial tool implemented on processing unit for applying business model conversion rules for supporting the allocation of assets to the consumer based on their rewards.

2. The computerized platform of claim 1 further comprising data usage collection module implemented on processing unit for aggregating usage parameters data from each application, product or service API according to defined usage parameters.

3. The computerized platform of claim 1 wherein the policy wizard determine or update the business module by applying a designated GUI process including at least one of the fowling steps:
defining the business module parameters including at least one of: type of financial assets or profit formula rules,
defining usages parameters of the application or ranking rating of user, product or service relevant for the business model including usage parameters, usage statistics, content provide by the user,
defining rewards conversion rules for the business model which define the calculation of the rewards form usage parameters; and
defining the assets allocation rules which determine the financial calculation of the financial assets values from the calculated rewards.

4. The computerized platform of claim 1 further comprising policy engine module which process the following steps: retrieving the business module parameters for each application products or service as defined by the owner together with the updated financial information of the owner, wherein based on the received information, the module determines or update the contract rules or state of the consumer based on current business model and generates Owner & End User Agreement.

5. The computerized platform of claim 4, wherein policy engine module further converts the updated contract rules or state in to financial assets allocation or transaction based on the business model.

6. The computerized platform of claim 1 wherein reward evaluation module receives the aggregated usage data of the consumer, analyzes statistics of usages for user or ranking at predefined time periods, wherein based on analyzed usage statistics the business module reward conversion rules are applied to determine accumulated rewards of each user.

7. The computerized platform of claim 6 wherein the accumulated rewards are recorded in the a client's database, wherein the database may store for each users all accumulated rewards for all type of applications, products and service, and provide each client full report of his rewards in comparison to his usage parameters.

8. The computerized platform, wherein the monetary module receives the accumulated rewards of the clients and applies the allocation conversion rules based on the business model and client personal information for calculating accumulated assets values of each client and store them in the client database.

9. The computerized platform, wherein the monetary module applies predefined countries rules adapted to business model asset allocation rules for calculating accumulated assets values of each client.

10. The computerized platform, wherein the monetary module, further provides connectivity or integration with financial tools for allocating or carrying out the financial outcome of the calculated allocated assets values, wherein the allocated assets values are stored in the financial transaction database.

11. A method implemented by main processor on at least one server for allocation of assets in relation to consumer usage of multiple application, products or services, said method comprised the steps of:
determining a business model using client processing terminal by defining application usage parameters or user rating data, rewarding conversion rules and assets allocation conversion rules;
determining and updating by user rewards scoring based on aggregated usage data or user rating data by applying determined rewarding conversion rules; and
applying business model conversion rules for supporting the allocation of assets to the consumer based on their rewards.

12. The method of claim 11 further comprising the step of: aggregating usage parameters data and ranking data from each application, product or service API according to defined usage parameters, wherein the aggregation is performed by processing unit on computer device or server.

13. The method of claim 11 wherein the determining or updating the business module is implemented by a designated GUI process including at least one of the fowling steps:
defining the business module parameters including at least one of: type of financial assets or profit formula rules,
defining usages parameters of the application or ranking rating of user, product or service relevant for the business model including usage parameters, usage statistics, content provide by the user,
defining rewards conversion rules for the business model which define the calculation of the rewards form usage parameters; and
defining the assets allocation rules which determine the financial calculation of the financial assets values from the calculated rewards.

14. The method of claim 11 further comprising the steps of retrieving the business module parameters for each application or service as defined by the owner together with the updated financial information of the owner and determining or updating the contract rules of the user based on current business model and generates Owner & End User Agreement.

15. The method of claim 11 further comprising the step of converting the updated contract state in to financial assets allocation based on the business model.

16. The method of claim 11 wherein determining and updating by user rewards include the steps of: receiving the aggregated usage data of the consumer, analyzing statistics of usages for user or ranking at predefined time periods, wherein based on analyzed usage statistics the business module reward conversion rules are applied to determine accumulated rewards of each user.

17. The method of claim 16 wherein the accumulated rewards are recorded in the a clients database, wherein the database may store for each users all accumulated rewards for all type of applications, products and service, and provide each client full report of his rewards in comparison to his usage parameters.

18. The method of claim 1, wherein applying business model conversion rules include the steps of receiving the accumulated rewards of the clients and applying the allocation conversion rules based on the business model and client personal information for calculating accumulated assets values of each client and store them in the client database.

19. The method of claim 1, further comprising the step of applying predefined countries rules adapted to business model asset allocation rules for calculating accumulated assets values of each client.

20. The method of claim 1 wherein the further comprising the step of providing connectivity or integration with financial tools for allocating or carrying out the financial outcome of the calculated allocated assets values, wherein the allocated assets values are stored in the financial transaction database.
